(19) United States
(12) Patent Application Publication
(10) Pub. No.: US 2004/0016160 A1
(43) Pub. Date: Jan. 29, 2004

(54) Bumper sticker kit and method

(76) Inventor: William M. Hudgins, Osteen, FL (US)

Correspondence Address: Edward M. Livingston, Esq., 628 Ellen Dr., P.O. Box 1599, Winter Park, FL, 32790, US

(21) Appl. No.: 10/208,499

(22) Filed: Jul. 29, 2002

(51) Int. Cl. G09F 7/16; G09F 7/04

(52) U.S. Cl. 40/600; 40/595

(57) ABSTRACT

A kit for enabling one to make his or her own bumper sticker with a personalized message. The kit includes a bumper sticker (1) having a blank writing surface on a front layer (5) and an attachment surface (8) on the attachment layer, which may be magnetic, for attaching it to any surface, such as a metal surface, of a motor vehicle (12). The kit also includes a writing means, such as felt tip marker (2) for writing a desired message on the writing surface (5) of the bumper sticker (1). An optional stencil of alphanumeric characters (11) may be provided to serve as a guide for writing a message on the bumper sticker (1). When it is desired to change the message on the bumper sticker, the message can be wiped or washed off or when indelible ink is used by simply replacing the bumper sticker with a second bumper sticker on which a second message can be written.

### BACKGROUND OF THE INVENTION

This invention relates to bumper stickers and more particularly to a kit for enabling one to make his or her own bumper sticker to display a desired personalized message.

Bumper stickers have long been a way of displaying a message on a motor vehicle, whether that message consists of a word or set of words, slogan, symbol, advertising or other form. Conventional bumper stickers come with pre-printed messages on the front side and adhesive on the back side for attaching them to a bumper or other surface of a motor vehicle. Such conventional bumper stickers present many problems. One problem is that the message is limited to those pre-printed messages which are currently available on the market and as such may not be a message desired by a person. Another problem is that the adhesive backing on conventional bumper stickers makes it difficult to remove and change bumper stickers as desired without difficulty. Often removing a bumper sticker requires scraping with a razor which can damage the surface of a vehicle to which the bumper sticker is attached. Often it is easier just to attach another bumper sticker over an old bumper sticker, thereby delaying the usual difficult and time-consuming removal process. Another problem with conventional bumper stickers is that one cannot change the message if desired from time to time. An even further problem with conventional bumper stickers is that they are not often removed timely due to the difficulty in removing them, thereby causing the message on the bumper sticker to become faded and worn with prolonged exposure to sunlight, rain and other elements.

Thus, a need exists for a bumper sticker kit which enables one to display personalized messages that can be easily changed when desired.

The prior art includes many bumper sticker related inventions, but none having the structure and simplicity of use as the present invention. For instance, U.S. Pat. No. 4,736,539 issued to Dickinson on Apr. 12, 1988, teaches an interchangeable bumper sticker holder. U.S. Pat. No. 3,959,906 issued Norris, Jr., et al. on Jun. 1, 1976, discloses a bumper sticker kit with blank bumper stickers which has stick on letters and a peel off-type adhesive back surface to attach it to a motor vehicle bumper. U.S. Pat. No. Des. 382,598 issued to Schroeppel on Aug. 19, 1997, teaches a suction cup mounted plastic sleeve-type bumper sticker holder. U.S. Pat. No. Des. 399,264, issued to Klink on Oct. 6, 1998, shows another design for a suction cup mounted bumper sticker holder. U.S. Pat. No. Des. 382,018 issued to Washington on Aug. 5, 1997, discloses a bottle-shaped design for a bumper sticker. U.S. Pat. No. Des. 429,283 issued to Conley, et al. on Aug. 8, 2000, discloses a bandage-like adhesive label. U.S. Pat. No. 5,626,551 issued to Kearns, et al. on May 6, 1997, teaches a kit for making greeting cards. U.S. Pat. No. 5,524,932 issued to Kalisher on Jun. 11, 1996, teaches a method of making a personalized children's story book having pre-printed pages with blank text portions to which transparent stickers with personalized text are attached. Finally, U.S. Pat. No. 5,487,010 issued to Drake, et al. on Jan. 23, 1996, discloses a machine for putting bumper stickers bearing a desired message.

### SUMMARY OF THE INVENTION

The objects of the present invention are to provide:

a bumper sticker which can display a personalized message designed by the user;

a bumper sticker which can be easily removed from the surface to which it is attached;

a bumper sticker that can be removed without causing damage to or leaving adhesive on the surface to which it is attached;

a bumper sticker on which a message can be changed as desired; and

optionally a stenciled guide means to assist in placing the message on the bumper sticker.

The present invention fulfills the above and other objects by providing a kit for creating a bumper sticker having at least one blank bumper sticker writing surface on a front side layer and attachment surface on the back side layer with a means capable for writing a message on the writing surface on the front side layer of the blank bumper sticker. The writing means may consist of a felt tip marker having indelible ink if a permanent message is desired or removable ink if a removable or wipe-off message is desired. Although the bumper stick may take any shape, it would preferably be rectangular to fit the width of a metal bumper to which it is attached. The kit may contain an optional stencil of alphanumeric characters to serve as a guide when writing the message. The detachable surface layer would be magnetic to make it easily removable. A method of use would simply involve writing the desired message using the writing means on the writing surface of the front side of the blank bumper sticker and applying the bumper sticker to a metallic surface by placing the magnetic back side to the metal surface. Then when desired, the message could be removed from the writing surface of the bumper sticker either by wiping or washing off the message, if impermanent ink is used, or replacing the entire bumper sticker with another bumper sticker and writing a new message on the replacement bumper sticker.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of the components of the bumper sticker kit in a package;

FIG. 2 is a front view showing the blank writing surface on the bumper sticker;

FIG. 3 is a back view showing the magnetic attachment surface of the bumper sticker;

FIG. 4 is an enlarged top view showing the two layers of the bumper stickers;

FIG. 5 is a perspective view showing a method being applied to the bumper sticker using an ink marker; and

FIG. 6 is a perspective view of the bumper sticker removably attached to the bumper of a motor vehicle.

### DESCRIPTION OF THE PREFERRED EMBODIMENTS

For purposes of describing the preferred embodiment, the terminology used in reference to the numbered components in the drawings is as follows:

| | |
|---|---|
| 1. | blank bumper sticker |
| 2. | ink marker |
| 3. | transparent plastic bag |
| 4. | package hang tag |
| 5. | front blank writing surface |
| 6a, b. | ends |
| 7a, b. | top and bottom, respectively |
| 8. | magnetic back |
| 9. | person's hand |
| 10. | message |
| 11. | optional alphanumeric |
| | stencil |
| 12. | motor vehicle |
| 13. | bumper |
| 14. | front layer |
| 15. | back magnetic layer |

Referring to the drawings, FIG. 1 shows the bumper sticker kit as it may come pre-packaged for retail sale, which includes the bumper sticker 1 with a marker 2 packaged in transparent plastic bag 3. The bag is secured between a two-sided hang tag 4 by staple or glue.

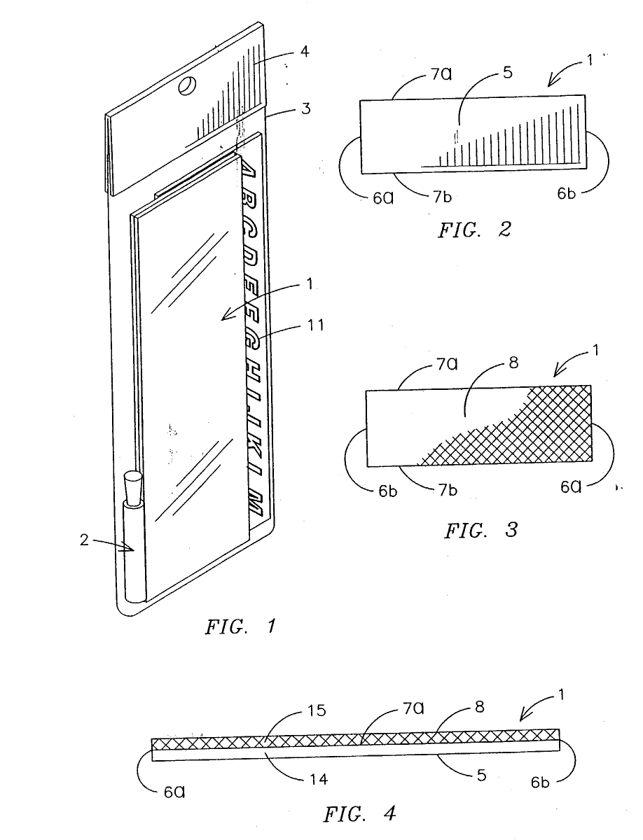

FIG. 2 shows the blank front writing surface 5 of the bumper sticker 1 and ends 6a and 6b and top 7a and bottom 7b of a rectangularly-shaped bumper sticker.

In addition, FIG. 3 shows back attachment surface 8 of the bumper sticker.

In FIG. 4 the two layers of the bumper sticker are shown, the front layer 14 which contains the writing surface 5 and the back layer 15 which contains the attachment surface 8. A front layer 14 would preferably be made of a coated plastic or other waterproof material. The back layer 15 would preferably be made of a plastic containing flexible magnetic material so that the bumper sticker could be removably attached to any metal surface.

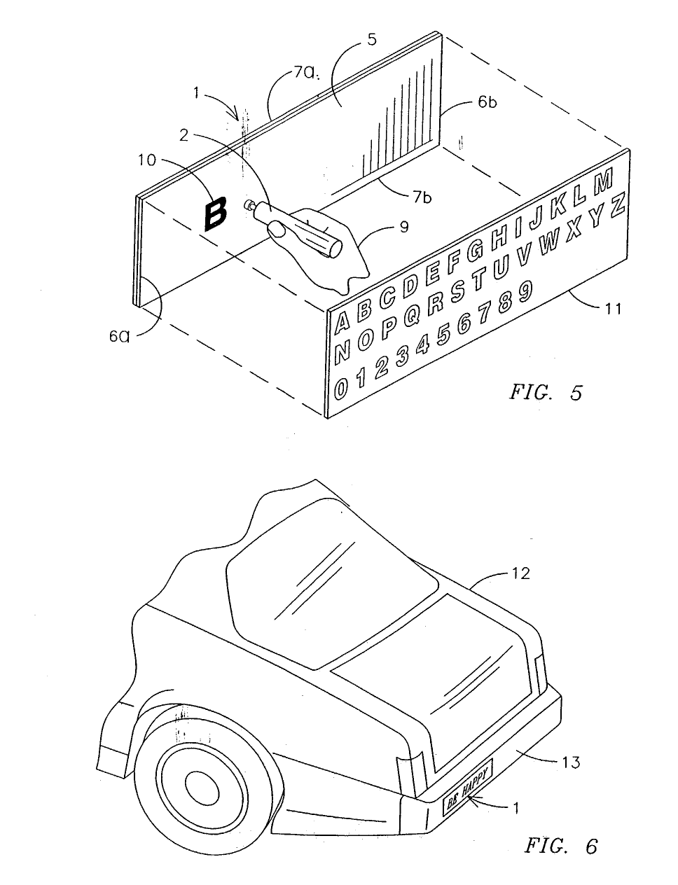

FIG. 5 shows a message 10 being written by a person holding a marker 2 in his or her hand 9 to the front writing surface 5 of the bumper sticker 1. Although the message 10 could be written in free hand, the kit may also include an optional stencil 11 containing alphanumeric characters to guide the felt tip marker 2 when writing the message for an overall neater appearance of the bumper sticker.

In FIG. 6 the bumper sticker 1 is shown being removably attached to a metallic bumper 13 of a motor vehicle 12.

As described hereinabove, a make your own bumper sticker kit has been provided which allows an individual to make his or her own bumper sticker and display a personalized message which can easily be changed as desired.

Although only a few embodiments of the present invention have been described in detail hereinabove, all improvements and modifications to this invention within the scope or equivalents of the claims are included as part of this invention.

Having thus described my invention, I claim:

1. A kit for creating a bumper sticker, said kit comprising:
at least one bumper sticker having a blank writing surface on a front side layer and an attachment surface on a back side layer for attachment to any surface; and
a writing means capable of writing a desired message on the blank writing surface on the front side layer of the at least one bumper sticker.

2. The kit of claim 1 wherein the writing means is a felt tip marker.

3. The kit of claim 1 wherein the blank writing surface on the front side is coated so that the message may be removed by wiping if desired.

4. The kit of claim 2 wherein the marker contains permanent ink so that the message on the writing surface cannot be removed.

5. The kit of claim 1 wherein the bumper sticker is rectangularly shaped.

6. The kit of claim 1 further comprising:
a stencil of alphanumeric characters to serve as guide for the writing means when writing a message on the bumper sticker.

7. The kit of claim 1 wherein the attachment surface layer is magnetic.

8. A method of making a bumper sticker from a kit which includes at least one bumper sticker having a blank writing surface on a front side layer and an attachment surface on a back side layer for attachment to a surface; and a writing means capable of writing a desired message on the writing surface on the front side layer of the at least one bumper sticker, said method comprising the steps of:
writing the desired message using the writing means onto the blank writing surface on the front side layer of the bumper sticker; and
applying the bumper sticker to a desired surface by attaching the bumper sticker to a suitable surface.

9. The method of claim 8 further comprising:
removing the message from the blank writing surface of the bumper sticker; and
replacing said message with another message by using the writing means to write another message on the blank writing surface of the bumper sticker.

10. The method of claim 8 further comprising:
removing the bumper sticker from a surface;
taking a second bumper sticker and writing another desired message using the writing means on the front surface of the second bumper sticker; and
applying the second bumper sticker to the surface.
